(19) United States
(12) Patent Application Publication
(10) Pub. No.: US 2025/0259804 A1
(43) Pub. Date: Aug. 14, 2025

(54) ARC CHUTE FOR AN ELECTRICAL SWITCH

(71) Applicant: Eaton Intelligent Power Limited, Dublin (IE)

(72) Inventors: Arthur James Jur; Abhishek Pratap Rao, Pune (IN); Miroslav Horký, Prague (CZ)

(21) Appl. No.: 18/441,707

(22) Filed: Feb. 14, 2024

(51) Int. Cl. H01H 9/34; H01H 9/36; H01H 73/18

(52) U.S. Cl. CPC H01H 9/342; H01H 9/362; H01H 73/18

(57) ABSTRACT

An arc chute apparatus includes: a housing that includes a first sidewall, a second sidewall, and an arc runner. The arc runner includes: a base portion integral with the housing and extending between the first sidewall and the second sidewall; and a tab that extends from the base portion and is configured to be oriented toward an electrical contact of a switching device. The arc runner is a ferrous material. The arc chute apparatus also includes an arc guide between the first sidewall and the second sidewall; an ablative insert in the housing; and mounting features configured to hold a plurality of ferrous plates in a spaced apart arrangement in the housing between the first sidewall and the second sidewall and between the arc guide and the arc runner.

### TECHNICAL FIELD

This disclosure relates to an arc chute for an electrical switch.

### BACKGROUND

An electrical switch includes a stationary electrical contact and a movable electrical contact. The state of the electrical switch is changed from ON to OFF and OFF to ON by moving the movable electrical contact relative to the stationary electrical contact.

### SUMMARY

In one aspect, an arc chute apparatus includes a housing that includes a first sidewall, a second sidewall, and an arc runner. The arc runner includes: a base portion integral with the housing and extending between the first sidewall and the second sidewall; and a tab that extends from the base portion and is configured to be oriented toward an electrical contact of a switching device. The arc runner is a ferrous material. The arc chute apparatus also includes an arc guide between the first sidewall and the second sidewall; an ablative insert in the housing; and mounting features configured to hold a plurality of ferrous plates in a spaced apart arrangement in the housing between the first sidewall and the second sidewall and between the arc guide and the arc runner.

Implementations may include one or more of the following features.

The base portion may be planar and the tab may extend in a different plane than the base portion. The tab may extend perpendicularly from the base portion.

The arc guide may include: a guide plate that extends between the first sidewall and the second sidewall, and a retention portion.

The ablative insert may include a first ablative insert adjacent to the first sidewall, and a second ablative insert adjacent to the second sidewall. The mounting features may include openings in the first ablative inert and openings in the second ablative insert.

The mounting features may include: a first mounting plate on an inner side of the first sidewall, a second mounting plate on an inner side of the second sidewall. The first mounting plate and the second mounting plate may be identical and include a plurality of openings each configured to receive a mounting portion of a ferrous plate or a mounting portion of the arc guide.

In another aspect, a switching device includes: a first electrical contact; a second electrical contact configured to move relative to the first electrical contact; and an arc chute apparatus. The arc chute apparatus includes: a housing with a first sidewall, a second sidewall, and an arc runner, the arc runner including: a base portion integral with the housing and extending between the first sidewall and the second sidewall, and a tab that extends from the base portion and is configured to be oriented toward one or more of the first electrical contact and the second electrical contact. The arc runner includes a ferrous material.

Implementations may include one or more of the following features.

The switching device also may include mounting features configured to hold a plurality of ferrous plates between the first sidewall and the second sidewall. The arc chute apparatus also may include an arc guide and mounting features configured to hold the plurality of ferrous plates between the arc guide and the arc runner.

The arc chute apparatus may be configured to be mounted to the first electrical contact.

The arc chute apparatus also may include an ablative insert in the housing. The ablative insert may include a first ablative insert adjacent to the first sidewall, and a second ablative insert adjacent to the second sidewall.

In another aspect, a housing assembly for an arc chute includes: a first sidewall; a second sidewall; interior mounting features configured to hold a plurality of ferrous plates between an interior side of the first sidewall and an interior side of the second sidewall; and an arc runner including: a base portion and a tab that extends from the base portion. An exterior of the housing assembly is configured for mounting to an electrical contact of a switching apparatus, the base portion is integrally attached to the interior side of the first sidewall and the interior side of the second sidewall, the base portion and the tab include a ferrous material, and the tab is configured to be positioned toward an arc generating location of the switching apparatus.

Implementations may include one or more of the following features.

The housing assembly also may include an arc guide.

The housing assembly also may include an ablative insert.

The interior mounting features may be openings in the ablative insert.

Implementations of any of the techniques described herein may include an apparatus, a device, a system, an arc chute apparatus, a housing for an arc chute apparatus, a switch, and/or a method. The details of one or more implementations are set forth in the accompanying drawings and the description below. Other features will be apparent from the description and drawings, and from the claims.

### DRAWING DESCRIPTION

FIG. 1 is a block diagram of a system.

FIGS. 2A and 2B are side views of a switch apparatus that includes an arc chute.

FIG. 2C is a front view of the arc chute of FIGS. 2A and 2B.

FIG. 2D is a cross sectional side view of the arc chute of FIGS. 2A and 2B.

FIG. 2E is an arc runner that is part of the arc chute of FIGS. 2A and 2B.

FIG. 2F is a perspective view of the arc guide that is part of the arc chute of FIGS. 2A and 2B.

FIG. 3A is a front view of another arc chute.

FIG. 3B is a cross-sectional view of the arc chute of FIG. 3A.

FIG. 3C is a plan view of a splitter plate that is part of the arc chute of FIG. 3A.

FIG. 4 is a perspective exploded view of another arc chute.

FIG. 5 is a perspective assembled view of the arc chute of FIG. 4 mounted to a switch apparatus.

### DETAILED DESCRIPTION

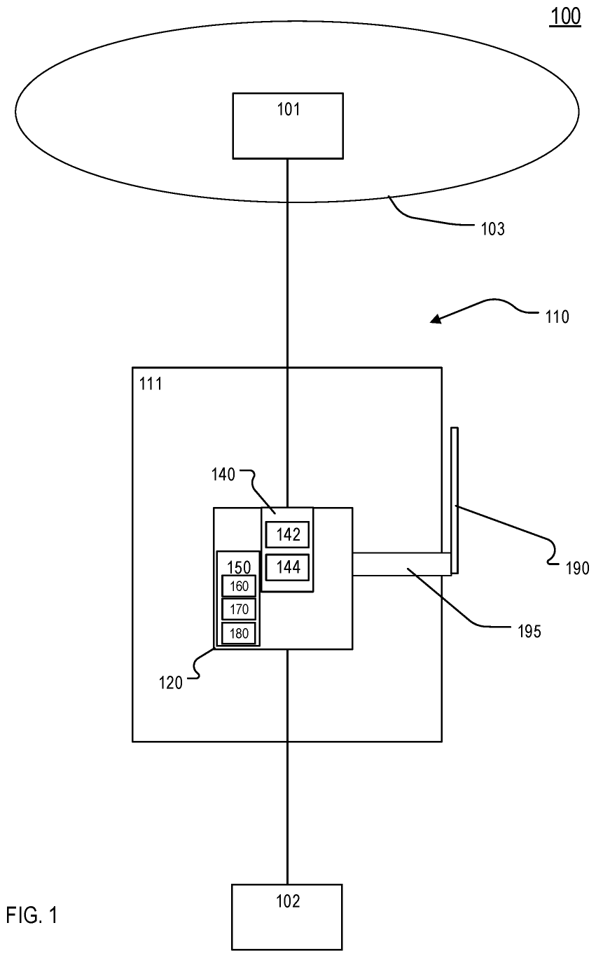

FIG. 1 is a block diagram of a system 100. The system 100 includes a switching system 110 that controls an electrical connection between a source 101 and a load 102. The switching system 110 may be, for example, a safety switch, a shunt trip safety switch, a circuit breaker (for example, a molded case circuit breaker), a switchgear, or a recloser.

The switching system 110 includes a switch apparatus 120. The switch apparatus 120 includes a switch module 140, which includes a stationary contact 144 and a movable contact 142 that moves relative to the stationary contact 144 to open or close the switch module 140. When the movable contact 142 is not electrically connected to the stationary contact 144, the switch module 140 is OFF or open, and the source 101 is disconnected from the load 102. When the movable contact 142 is electrically connected to the stationary contact 144, the switch module 140 is ON or closed, and the source 101 is electrically connected to the load 102.

The switch apparatus 120 also includes an arc chute 150 that dissipates arcs that can form when the switch module 140 opens. To open the switch apparatus 120, the movable contact 142 is separated from the stationary contact 144. If current is flowing in the switch module 140 when the movable contact 142 separates from stationary contact 144, an arc may form in the space between the movable contact 142 and the stationary contact 144. Such an arc is generally undesirable. For example, the arc can electrically connect the stationary contact 144 and the movable contact 142 even though the contacts 144 and 142 are not in direct physical contact. Thus, the arc may provide a path for current to flow in the switch module 140 when the switch module 140 is intended to be open. Additionally, the arc can vaporize the surface of the stationary contact 144 and/or the movable contact 142. The vaporization may degrade the contact 142 and/or 144 and reduce the life of the switch module 140.

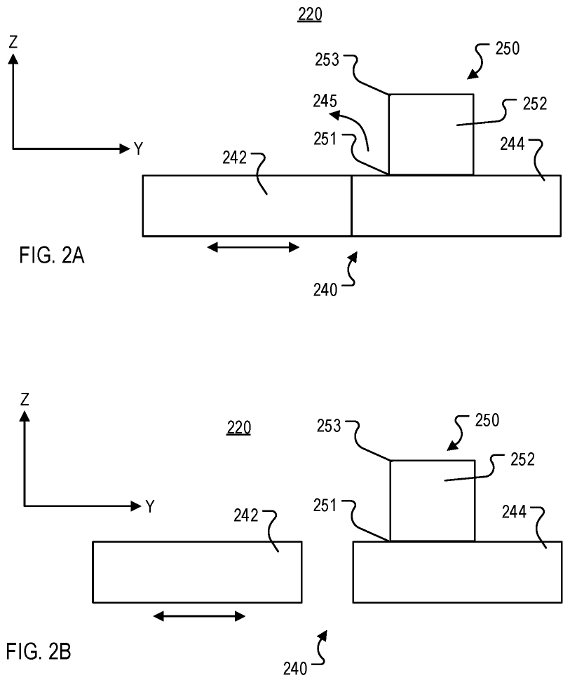

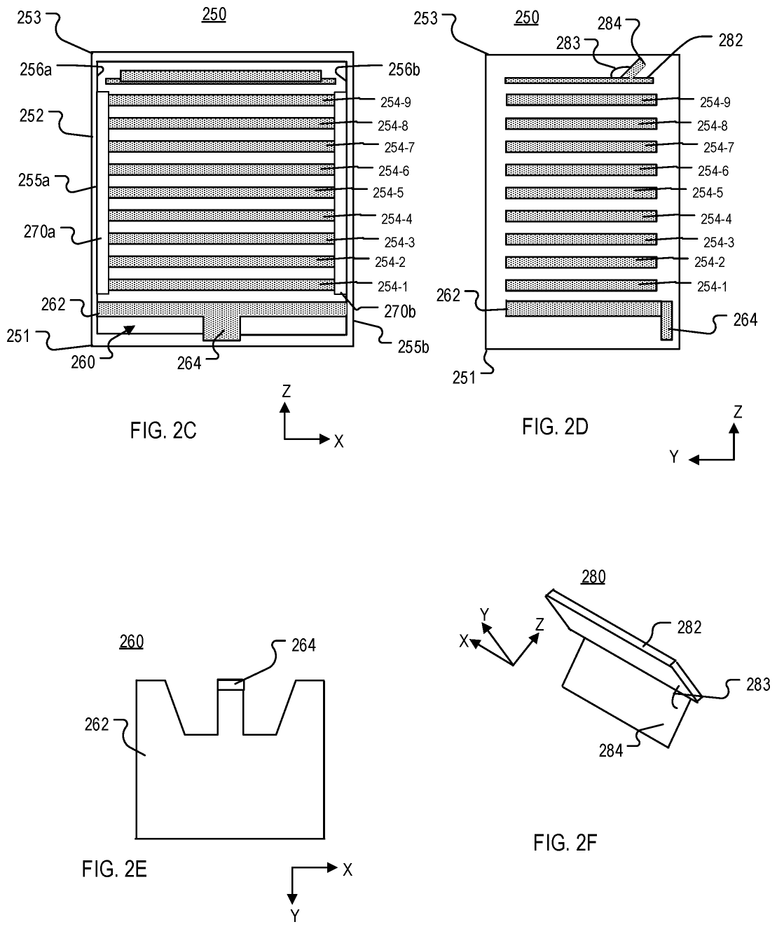

The arc chute 150 dissipates and/or extinguishes the arc. The arc chute 150 houses an integral arc runner 160, an ablative material insert 170, an arc guide 180, and splitter plates (such as shown in FIGS. 2A-2C) to increase the ability of the arc chute 150 to dissipate arcs. The arc runner 160 is integral with the arc chute 150 such that when the arc chute 150 is removed from the switch apparatus 120, the arc runner 160 is also removed. The arc runner 160 pulls the arc into the arc chute 150 and the arc guide 180 encourages the arc to remain in the arc chute 150, thereby increasing the exposure of the arc to the ablative material insert 170 and quenching the arc. Retaining the arc in the arc chute 150 also eliminates or reduces discharge of hot gasses and plasma into the environment around the switch apparatus 120. The arc chute 150 may dissipate an arc created by opening a switch rated for 800 or 1000 Volt (V) switching in an air switching medium. Furthermore, the configuration of the arc chute 150 allows for a visible break or visible blade feature in the switch apparatus 120. For example, the arc chute 150 design and placement is in such a way that, when the moveable contact 142 is moved from one position to another, the position of the moveable contact 142 is visible from a door viewing window of the switch apparatus 120. The arc chute 150 do not obstruct the visibility of the movable contact 142 as viewed from switch front.

Before discussing examples of the arc chute 150 in more detail, an overview of various components of the system 100 is provided.

The source 101 is any kind of AC power source. For example, the source 101 may be a generator, a power plant, a distributed energy resource (DER), or a node or feeder in an AC power grid. A DER is an electricity-producing resource and/or a controllable load. Examples of DERs include, without limitation, solar-based energy sources such as, for example, solar panels and solar arrays; wind-based energy sources, such as, for example, wind turbines; combined heat and power plants; rechargeable sources (such as batteries); natural gas-fueled generators; electric vehicles; and controllable loads, such as, for example, some heating, ventilation, air conditioning (HVAC) systems, and electric water heaters.

The load 102 is any device or system that consumes, transfers, absorbs, and/or produces electrical power. For example, the load 102 may be a motor; a lighting system; a distributed energy resource (DER); an uninterruptable power supply, a capacitor, a power-factor correction device (such as a capacitor bank), or a transformer. The load 102 may be located at a customer site, such as, for example, a residence or an industrial facility. The load 102 may include more than one device.

In the example of FIG. 1, the source 101 is part of a grid or electrical power distribution network 103. The electrical power distribution network 103 may be, for example, a multi-phase electrical power grid that provides electricity to industrial, commercial, and/or residential customers. The AC electrical power distribution network 103 distributes AC electrical power that has a fundamental frequency of, for example, 50 or 60 Hertz (Hz). The AC electrical power distribution network 103 may be low-voltage (for example, up to 1 kilovolt (kV)), medium-voltage or distribution voltage (for example, between 1 kilovolts (kV) and 35 kV), or high-voltage (for example, 35 kV and greater).

The distribution network 103 may include more than one sub-grid or portion. For example, the distribution network 103 may include AC micro-grids, AC area networks, or AC spot networks that serve particular customers. These sub-grids may be connected to each other via switches and/or other devices to form the network 103. Moreover, sub-grids within the network 103 may have different nominal voltages. For example, the network 103 may include a medium-voltage portion connected to a low-voltage portion through a distribution transformer.

All or part of the network 103 may be underground. The network 103 may include additional components and devices such as, for example, one or more transmission lines, distribution lines, power distribution or substation transformers, electrical cables, and/or any other mechanism for transmitting electricity.

The switch apparatus 120 is supported and/or enclosed in a housing 111. The state of the switch apparatus 120 is determined by the state of the switch module 140. The switch module 140 is any type of switch that has at least an ON state and an OFF state. For example, the switch module 140 may be a double make, double break switch that includes a movable conductor and that interacts with two stationary contacts, a knife-type switch, a bolted pressure contact switch, or a blade-type switch. The switch module 140 is configured for repeated operation. For example, the switch module 140 may be opened and closed repeatedly over its lifetime.

The switch module 140 is capable of interrupting current having an amplitude that is appropriate for the application of the switching system 110. The rating of the switching system 110 may be, for example, 30 Amperes (A), 60 A, 100 A, 200 A, 400 A, 600 A, 800 A, 1200 A, or greater. Although only one switch module 140 is shown in FIG. 1, the switch apparatus 120 may include more than one switch module 140. For example, the switch apparatus 120 may be a three-phase switch apparatus that includes three instances of the switch module 140, one for each phase.

The switching system 110 also includes an operating interface 190 and a driving assembly 195 coupled to the operating interface 190. The driving assembly 195 is coupled to the movable contact 142 such that the state of the switch module 140 is controllable with the operating interface 190. In implementations that include more than one instance of the switch module 140, the driving assembly 195 is coupled to all of the switch modules 140 such that manipulating the operating interface 190 changes the state of all of the switch modules 140 simultaneously to thereby also change the state of the switch apparatus 120.

The operating interface 190 is any type of interface that has at least two stable states or positions and is accessible from an exterior of the support or housing 111. For example, the operating interface 190 may be a handle that moves through a range of motion between two endpoints but is only stationary at the endpoints, where one endpoint corresponds to the switch apparatus 120 being in the OFF state and the other endpoint corresponds to the switch apparatus 120 being in the ON state. In another example, the operating interface 190 may be a push-button interface or an electronic interface.

The driving assembly 195 is any type of assembly that is capable of translating the operation of the operating interface 190 to the movable contact 142. For example, the driving assembly 195 may include a mechanical linkage, a shaft, gears, motors, plungers, springs, actuators, or a combination of such devices.

The switching system 110 also may include additional components that are not shown. For example, the switching system 110 a fuse holding assembly. The fuse holding assembly is any type of assembly that holds fuses. For example, the fuse holding assembly may be one or more fuse clips. The fuse holding assembly may be configured to allow removal and replacement of a fuse that has operated. In implementations that include a fuse holding assembly, the switching system 110 may be shipped or transported without the fuses and the fuses may be installed by the end-user or manufacturer. However, the switching system 110 may be used without fuses and may be constructed without a fuse holding assembly.

FIGS. 2A and 2B are side views of a switch apparatus 220. The switch apparatus 220 includes an arc chute 250 that dissipates arcs that may form when the switch apparatus 220 is opened. FIGS. 2C and 2D show the arc chute 250.

Referring to FIGS. 2A and 2B, the switch module 240 includes a stationary contact 244 and a movable contact 242 that moves relative to the stationary contact 244 to open or close the switch module 240. When the switch module 240 is closed (FIG. 2A), the movable contact 242 is in physical contact with the stationary contact 244. When the switch module 240 is open (FIG. 2B), the movable contact 242 is not in physical contact with the stationary contact 244. To open the switch module 240, the movable contact 242 is separated from the stationary contact 244. For example, the movable contact 242 may be translated along a linear path in the −Y direction or rotated along an arc 245 (FIG. 2A).

Referring also to FIG. 2C, which is a front view of the arc chute 250 in the X-Z plane, and FIG. 2D, which is a cross sectional side view of the arc chute 250 in the Y-Z plane, the arc chute 250 includes a housing 252 and a plurality of plates 254-1 to 254-9 (collectively referred to as the plates 254) in the housing 252. The housing 252 extends in the Z direction from a first end 251 to a second end 253. The first end 251 of the housing 252 is mounted on the stationary contact 244. The housing 252 includes a first sidewall 255a and a second sidewall 255b. The first and second sidewalls 255a, 255b are parallel to each other and extend generally in the Y-Z plane. The housing 252 may be made of an electrically insulating material, such as, for example, a polymeric material.

The plates 254 are mounted in the housing 252 and are electrically insulated from each other. The plates 254 are mounted in the housing 252 by mounting features (not shown) that mechanically secure the plates 254 to an inner wall 256a of the first sidewall 255a and to an inner wall 256b of the second sidewall 255b. The mounting features may be openings in the inner walls 256a, 256b (or openings on mounting plates that are on the inner walls 256a, 256b) that accept corresponding features (for example, tabs or posts) on the plates 254. In some implementations, ablative material inserts 270a, 270b include the mounting features.

In the example of FIGS. 2C and 2D, each plate 254 extends in the X-Y plane. The plates 254 are substantially parallel to each other and perpendicular to the sidewalls 255a, 255b. The plates 254 may be made of an electrically conductive material, for example, a ferrous metal such as steel. The plates 254 are electrically insulated from each other by air and/or another insulating material disposed between the plates 254. In the example of FIGS. 2C and 2D, the plates 254 are separated by gaps in the Z direction.

Other implementations are possible. For example, the plates 254 may be angled relative to the X-Y plane and are not necessarily parallel to each other. Moreover, the plates 254 are not necessarily rectangular in shape. For example, the plates 254 may include cut portions or notches to encourage the arc to enter and remain in the chute 250.

The arc runner 260 is integrally attached to the inner wall 256a and the inner wall 256b. Referring also to FIG. 2E, which shows the arc runner 260, the arc runner 260 includes a base portion 262 that extends from the inner wall 256a to the inner wall 256b, and a tab 264 extends away from the base portion 262 in the −Z direction. The base portion 262 is planar, plate-like structure. The arc runner 260 is a single-piece structure, and the base portion 262 and the tab 264 are permanently attached to each other. For example, the arc runner 260 may be formed as a single metal part, or the tab 264 may be a bar, block, or sheet that is welded or brazed to the base portion 262. The tab 264 is a ferrous material such as, for example, steel. The base portion 262 may be the same material as the tab 264.

The arc runner 260 is integral with the housing 252 such that the arc runner 260 is part of the arc chute 250. For example, the base portion 262 may be permanently attached to the inner walls 256a, 256b with, for example, an adhesive, mechanical fastener, or surface feature. An example of a surface feature is a slot in each of the inner walls 256a, 256b that receive and hold the base 262 in the housing 252. In some implementations, the housing 252 and the arc runner 260 are extruded or molded as a single piece. The arc runner 260 is close to the first end 251 of the housing.

Referring also to FIG. 2F, which is a perspective view of the arc guide 280, the arc guide 280 includes a guide plate 282 and a retention plate 284. The retention plate 284 extends from the guide plate 282 at an angle 283. The angle 283 may be greater than 90 degrees (°) and less than 180°. The guide plate 282 is secured to the inner wall 256a and the inner wall 256b with mounting features. For example, the guide plate 282 may include protrusions that are held in corresponding openings in the inner wall 256a and the inner wall 256b.

When installed in the housing 259, the arc guide 280 extends between the inner wall 256a and the inner wall 256b with the retention plate 284 oriented toward the second end 253. The arc guide 280 is near the second end 253 of the housing 252. The plates 254 are between the arc guide 280 and the arc runner 260.

The ablative material insert 270a is along the inner wall 256a, and the ablative material insert 270b is along the inner wall 256b. The plates 254, the arc runner 260, and the guide plate 282 may be attached to the inserts 270a, 270b to form a sub-assembly that is mounted in the housing 259 between the inner walls 256a, 256b. The insert 270a and the insert 270b may be held to the respective inner wall 256a and 256b by a tight fit or an adhesive. The ablative material inserts 270a and 270b may be sheets, masks, foams, or plates of any ablative material. The ablative material may be any type of material that erodes and/or vaporizes in the presence of heat. The erosion and/or vaporization may produce a layer of gas and/or material that deflects and/or absorbs heat to reduce the temperature of the arc. Examples of ablative material that may be used for the inserts 270a, 270b include, without limitation, cellulous filled melamine (CFM), fish paper, or a vulcanized fiber material.

In operational use of the switch apparatus 220, the arc chute 250 is mounted to the stationary contact 244 with the tab 264 of the arc runner 260 oriented toward the path of the movable contact 242 and toward the likely location of the arc. For example, the tab 264 may be in physical contact with the stationary contact 244 and facing toward the movable contact 242.

In operational use of the switch module 240, electrical current may flow in the switch module 240 when the module 240 is closed (FIG. 2A). To open the switch module 240, the movable contact 242 is separated from the stationary contact 244. If current is flowing in the switch module 240 when the movable contact 242 separates from the stationary contact 244, an arc may form in the open space between the separated contacts 242 and 244. The tab 264 and the arc runner 260 include a ferrous material that draws the arc into the arc chute 250 through magnetic force. The arc enters the arc chute 250 and dissipates through interactions with the plates 254 and the ablative material inserts 270a, 270b. The arc is also retained in the arc chute 250 by the arc guide 280. Retaining the arc in the arc chute 250 provides additional time for the arc to cool, dissipate, and/or be quenched by the ablative material inserts 270a, 270b. In this way, the configuration of the arc chute 250 reduces or eliminates damage that could be caused by the arc, thereby improving the overall performance of the switch module 240.

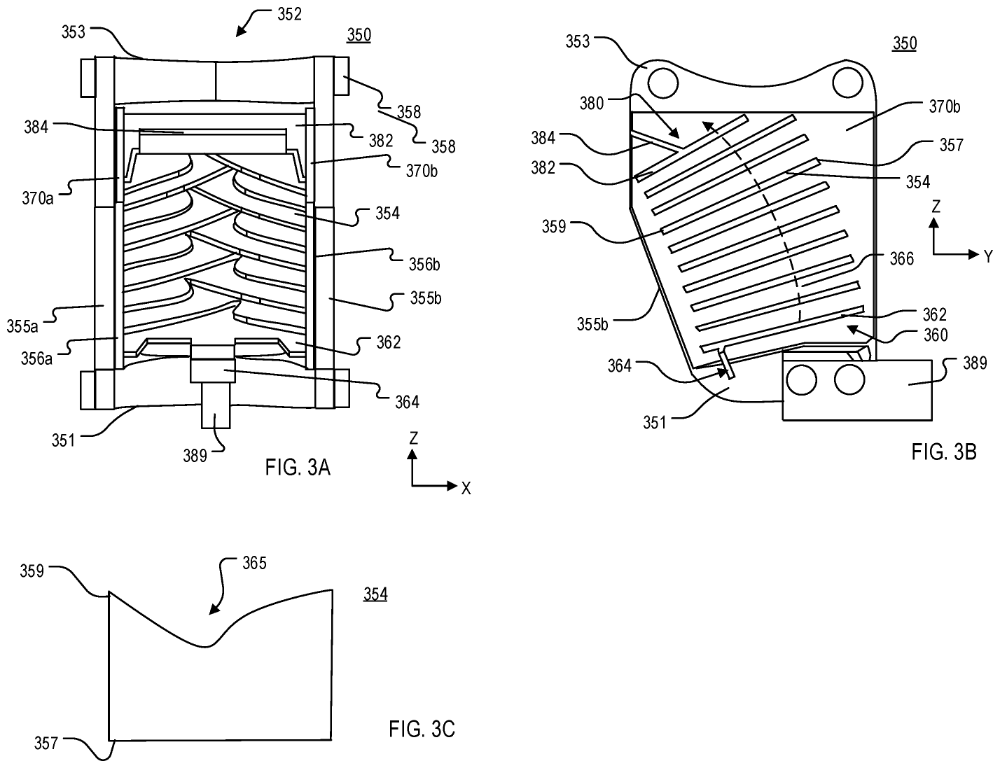

FIG. 3A is a front view of an arc chute 350. FIG. 3B is a cross-sectional view of the arc chute 350. The arc chute 350 is another example of an arc chute that may be used in the switch apparatus 120 (FIG. 1). The arc chute 350 includes a housing 352 that includes a first portion 355a and a second portion 355b. The first and second portions 355a and 355b are held together by fasteners 358. The fasteners 348 may be, for example, bolts or screws. The first and second portions 355a and 355b may be molded housings made of a polymeric material. When assembled, the housing 352 extends from a first end 351 to a second end 353.

The arc chute 350 includes a first ablative insert 370a on an interior wall 356a of the portion 355a, and a second ablative insert 370b on an interior wall 356b of the portion 355b. The arc chute 350 also includes an arc runner 360, an arc guide 380, and a plurality of plates 354 between the arc runner 360 and the arc guide 380. For simplicity only one of the plates 354 is labeled. Each plate 354 is mounted to the interior wall 356a and the interior wall 356b and extends between the interior walls 356a and 356b. The plates 354, the arc runner 360, and the arc guide 380 may be made of a ferrous material, such as, for example, steel or an iron alloy.

The arc runner 360 includes a base portion 362 and a tab 364 that extends from the base portion 362. The base portion 362 extends in a different plane than the tab 364. The base portion 362 is mounted to the interior walls 356a and 356b and extends between the interior walls 356a and 356b.

The arc guide 380 includes a guide plate 382 and a retention portion 384 that extends at an angle from the guide plate 382. The guide plate 382 is mounted to the interior walls 356a and 356b and extends between the interior walls 356a and 356b. The retention portion 384 extends toward the second end 353.

Referring also to FIG. 3C, the plates 354 are planar structures that extend from a bottom end 357 to a top end 359. The top end 359 includes a notch or cut portion 365. The profile of the notch or cut portion 365 may be different for each plate 354. The cut portions 365 help to guide the arc into the arc chute 350. As shown in FIG. 3B, the plates 354 are separated from each other, from the arc runner 360, and from the arc guide 380. The plates 354 are arranged in a spaced apart manner that follows a path 366 in the Y-Z plane. The plates 354 are not parallel with the X, Y, or Z axis and may be angled at different angles relative to one of the axis. The base portion 362 of the arc runner 360 and the guide plate 382 of the arc guide 380 are also not parallel with the X, Y, or Z axis.

The arc chute 350 also includes an exterior mounting assembly 389. The exterior mounting assembly 389 may be, for example, a bracket or block that attaches to the portions 355a and/or 355b and an electrical contact of a switching apparatus (such as the switch apparatus 120 of FIG. 1). For example, the exterior mounting assembly 389 may be used to attach the arc chute 350 to the stationary contact 144.

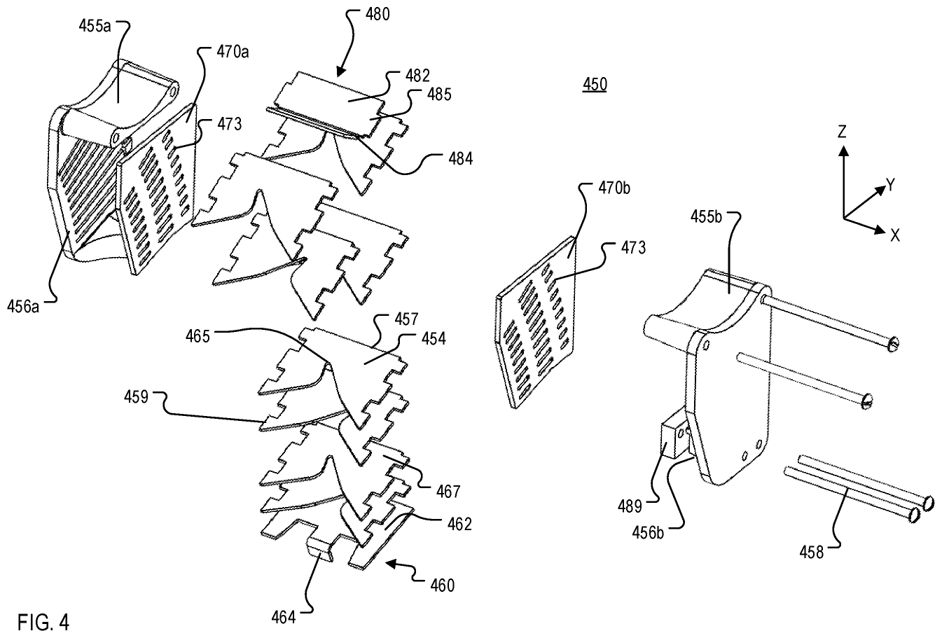

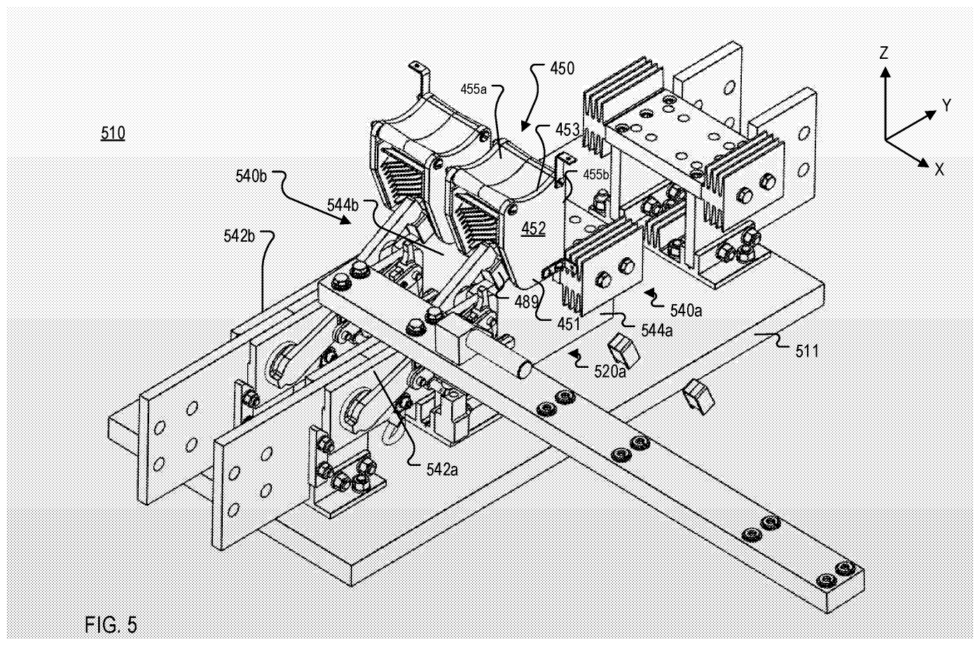

FIG. 4 is a perspective exploded view of an arc chute 450. FIG. 5 is a perspective view of the arc chute 450 assembled and mounted to a switch apparatus 520a in a switching system 510. The arc chute 450 may be used with other switching systems, such as, for example, the switching system 110 of FIG. 1.

The arc chute 450 includes a first housing portion 455a and a second housing portion 455b held together by bolts 458 to form a housing 452 (FIG. 5). The first and second housing portions 455a and 455b are made of an electrically insulating material, such as, for example, a polymeric material. The housing 452 extends from a first end 451 to a second end 453.

The arc chute 450 also includes an arc runner 460, an arc guide 480, and a plurality of plates 454 (only one of which is labeled in FIG. 4). Each plate 454 includes a planar portion that extends from a first end 457 to a second end 459 and a cut portion 465 at the second end 459. Each plate 454 may have a cut portion 465 with a different profile. Each plate 454 also includes mounting features 467 that extend generally the same plane as the planar portion of the plate 454. The mounting features 467 are tabs in the example of FIG. 4, but other mounting features may be used. For example, the mounting features 467 may be posts.

The arc runner 460 includes a base portion 462 and a tab 464 that extends from the base portion 462. In the example of FIG. 4, the base portion 462 extends in the X-Y plane, and the tab extends in the-Z direction. The arc guide 480 includes a guide plate 482 and a retention portion 484 that extends at an angle from the guide plate 482. The guide plate 482 also includes mounting features 485 that extend in generally the same plane as the guide plate 482.

The arc chute 450 includes a first ablative material insert 470a and a second ablative material insert 470b. Each ablative material insert 470a, 470b is configured to be placed against a respective interior wall 456a, 456b of the housing portion 455a, 455b. The ablative material inserts 470a, 470b are plates or sheets of ablative material that extend in the same plane of the interior walls 456a, 456b (generally the Y-Z plane in FIG. 4). The ablative material inserts 470a, 470b include openings 473, only one of which is labeled in FIG. 4. The openings 473 are arranged in the same pattern on the insert 470a and the insert 470b.

Each opening 473 accepts one of the mounting features 467 or one of the mounting features 485. When the ablative material inserts 470a, 470b are attached to respective interior walls 456a, 456b and when the openings 473 accept the mounting features 467 and 485, the plates 454 and the arc guide 480 are mounted in the housing 452. When mounted in the housing, the plates 454 and the arc guide 480 extend along the X direction between the interior wall 465a and the interior wall 465b, with the arc guide at the end 453 of the housing 452 and the arc runner 460 at the end 451 of the housing 452. The plates 454, the arc runner 460, and the arc guide 480 may be made of a ferrous material, such as, for example, steel or an iron alloy.

Referring to FIG. 5, the switching system 510 includes two switch modules: a switch module 540a and a switch module 540b mounted on a support 511. Each switch module 540a, 540b includes a respective stationary contact 544a, 544b and a respective movable contact 542a, 542b. The arc chute 450 is mounted to the stationary contact 544a by attaching a mounting block 489 to the stationary contact 544a. When mounted to the stationary contact 544a, the arc chute 450 is oriented such that the arc runner 460 and the tab 464 face the movable contact 542b. This positioning helps to ensure that the arc enters the arc chute 450.

These and other implementations are within the scope of the claims.

What is claimed is:

1. An arc chute apparatus comprising:
a housing comprising a first sidewall, a second sidewall, and an arc runner, the arc runner comprising: a base portion integral with the housing and extending between the first sidewall and the second sidewall; and a tab that extends from the base portion and is configured to be oriented toward an electrical contact of a switching device, wherein the arc runner comprises a ferrous material;
an arc guide between the first sidewall and the second sidewall;
an ablative insert in the housing; and
mounting features configured to hold a plurality of ferrous plates in a spaced apart arrangement in the housing between the first sidewall and the second sidewall and between the arc guide and the arc runner.

2. The arc chute apparatus of claim 1, wherein the base portion is planar and the tab extends in a different plane than the base portion.

3. The arc chute apparatus of claim 2, wherein the tab extends perpendicularly from the base portion.

4. The arc chute apparatus of claim 1, wherein the arc guide comprises: a guide plate that extends between the first sidewall and the second sidewall, and a retention portion.

5. The arc chute apparatus of claim 1, wherein the ablative insert comprises a first ablative insert adjacent to the first sidewall, and a second ablative insert adjacent to the second sidewall.

6. The arc chute apparatus of claim 5, wherein the mounting features are openings in the first ablative inert and openings in the second ablative insert.

7. The arc chute apparatus of claim 1, wherein the mounting features comprise: a first mounting plate on an inner side of the first sidewall, a second mounting plate on an inner side of the second sidewall.

8. The arc chute apparatus of claim 7, wherein the first mounting plate and the second mounting plate are identical and include a plurality of openings each configured to receive a mounting portion of a ferrous plate or a mounting portion of the arc guide.

9. A switching device comprising:
a first electrical contact;
a second electrical contact configured to move relative to the first electrical contact; and
an arc chute apparatus comprising:
a housing comprising a first sidewall, a second sidewall, and an arc runner, the arc runner comprising: a base portion integral with the housing and extending between the first sidewall and the second sidewall; and a tab that extends from the base portion and is configured to be oriented toward one or more of the first electrical contact and the second electrical contact, wherein the arc runner comprises a ferrous material.

10. The switching device of claim 9, further comprising mounting features configured to hold a plurality of ferrous plates between the first sidewall and the second sidewall.

11. The switching device of claim 10, wherein the arc chute apparatus further comprises an arc guide, and mounting features configured to hold the plurality of ferrous plates between the arc guide and the arc runner.

12. The switching device of claim 9, wherein the arc chute apparatus is configured to be mounted to the first electrical contact.

13. The switching device of claim 9, wherein the arc chute apparatus further comprises an ablative insert in the housing.

14. The switching device of claim 13, wherein the ablative insert comprises a first ablative insert adjacent to the first sidewall, and a second ablative insert adjacent to the second sidewall.

15. A housing assembly for an arc chute, the housing assembly comprising:
a first sidewall;
a second sidewall;
interior mounting features configured to hold a plurality of ferrous plates between an interior side of the first sidewall and an interior side of the second sidewall; and
an arc runner comprising: a base portion and a tab that extends from the base portion, wherein an exterior of the housing assembly is configured for mounting to an electrical contact of a switching apparatus, the base portion is integrally attached to the interior side of the first sidewall and the interior side of the second sidewall, the base portion and the tab comprise a ferrous material, and the tab is configured to be positioned toward an arc generating location of the switching apparatus.

16. The housing assembly of claim 15, further comprising an arc guide.

17. The housing assembly of claim 16, further comprising an ablative insert.

18. The housing assembly of claim 17, wherein the interior mounting features comprise openings in the ablative insert.
